(19) United States
(12) Patent Application Publication
(10) Pub. No.: US 2020/0295394 A1
(43) Pub. Date: Sep. 17, 2020

(54) IONIC LIQUID CONDUCTIVE MEMBRANE AND METHODS OF FABRICATING SAME

(71) Applicants: University of Maryland, College Park, College Park, MD (US); National Institute of Standards and Technology (NIST), Gaithersburg, MD (US)

(72) Inventors: Mohamad I. Al-Sheikhly, Potomac, MD (US); Kevin Mecadon, Basking Ridge, NJ (US); Zois Tsinas, College Park, MD (US); Joseph W. Robertson, Gaithersburg, MD (US)

(21) Appl. No.: 16/819,123

(22) Filed: Mar. 15, 2020

Related U.S. Application Data
(60) Provisional application No. 62/819,111, filed on Mar. 15, 2019.

(51) Int. Cl. H01M 8/1048; H01M 8/1023; H01M 8/1039; H01M 8/1072; H01M 8/1088

(52) U.S. Cl. CPC H01M 8/1048; H01M 8/1023; H01M 2008/1095; H01M 8/1072; H01M 8/1088; H01M 8/1039

(57) ABSTRACT

An ionic liquid grafted conductive membrane for fuel cells is disclosed. In accordance with aspects, a fuel cell includes a membrane having: ionic liquid monomers physically covalently bonded to a fluorocarbon polymer substrate, and a solid-state proton conductive network configured to conduct protons above 100° C.

### CROSS-REFERENCE TO RELATED APPLICATION

This application claims the benefit of, and priority to, U.S. Provisional Patent Application No. 62/819,111, filed on Mar. 15, 2019. The entire contents of the foregoing application are hereby incorporated by reference.

### GOVERNMENT SUPPORT STATEMENT

This invention was made with government support under NRCHQ12G380023 awarded by Nuclear Regulatory Commission. The government has certain rights in the invention.

### BACKGROUND

### Technical Field

The present disclosure relates to conductive membranes, and more particularly, to conductive membranes for fuel cells.

### Related Art

High-performance fuel cells are a key component to advancing the global effort to increase energy utilization efficiency in both portable and stationary power generation. Proton-exchange membrane fuel cells, also known as polymer electrolyte membrane (PEM) fuel cells, are a type of fuel cell suitable for stationary power applications as well as portable power applications.

A common membrane in PEM fuel cells relies on liquid water to humidify the membrane for proton exchange. Such membranes do not operate well at temperatures above 80 to 90° C., which cause water in the membrane to dry. Higher temperatures enable fuel cells to operate more efficiently by enhancing reaction kinetics, increasing catalysis activity, and reducing carbon monoxide poisoning of the electrodes. However, operating above the boiling point of water leads to dehydration of the membrane and loss of proton conductivity. Improving membrane technology is an important aspect of advancing commercial fuel cell applications. Accordingly, there is continuing interest in developing and improving fuel cell technology.

### SUMMARY

The present disclosure relates to ionic liquid grafted conductive membranes for fuel cells.

In accordance with aspects of the present disclosure, a fuel cell includes a membrane having: ionic liquid monomers physically covalently bonded to a fluorocarbon polymer substrate, and a solid-state proton conductive network configured to conduct protons above 100° C.

In various embodiments of the fuel cell, the ionic liquid monomers are heterocyclic protic.

In various embodiments of the fuel cell, the ionic liquid monomers include at least one vinyl group.

In various embodiments of the fuel cell, the membrane includes ionomer nanochannels, and the ionomer nanochannels include hydrogen bond networks.

In various embodiments of the fuel cell, the fluorocarbon polymer substrate includes a fluoropolymer having a functional group which provides protection to a polymer backbone.

In various embodiments of the fuel cell, the fluorocarbon polymer substrate includes at least one of: fluorinated ethylene propylene (FEP), polychlorotrifluoroethylene (PCTFE), or polyvinylfluoride (PVF).

In various embodiments of the fuel cell, the ionic liquid includes at least one of: 4-vinylpyridine, 5-vinylpyrimidine, 5-vinylbenzoimidazole, or 2-vinylimidazole, 4-vinylimidazol, 5-vinyl(1,2,3 triazine), 2-vinyl(1,2,5 triazine), 4-vinylbenzene (1 boronic acid), 5-vinylbenzene (1,3 diboronic acid), 2-vinylbenzene (1,3,5 triboronic acid), 4-vinylbenzoic acid, 5-vinylbenzene (1,3 dicarboxylic acid), 2-vinylbenzene (1,3,5 tricarboxylic acid), 4-vinylbenzene (1 sulfonic acid), 5-vinylbenzene (1,3 disulfonic acid), 2-vinylbenzene (1,3,5 trisulfonic acid), 4-vinylbenzene (1 sulfuric acid), 5-vinylbenzene (1,3 disulfuric acid), 2-vinylbenzene (1,3,5 trisulfuric acid), 4-vinylbenzene (1 phosphonic acid), 5-vinylbenzene (1,3 diphosphonic acid), 2-vinylbenzene (1,3,5 triphosphonic acid), 4-vinylbenzene (1 phosphoric acid), 5-vinylbenzene (1,3 diphosphoric acid), 2-vinylbenzene (1,3,5 triphosphoric acid), allyl counterparts of the foregoing vinyl monomers, or butylene counterparts of the foregoing vinyl monomers.

In various embodiments of the fuel cell, the ionic liquid monomers are diffused through a depth of the fluorocarbon polymer substrate.

In various embodiments of the fuel cell, the depth is an entire depth of the fluorocarbon polymer substrate, and the ionic liquid monomers are uniformly diffused through the entire depth of the fluorocarbon polymer substrate.

In various embodiments of the fuel cell, the membrane conducts protons independent of humidity.

In various embodiments of the fuel cell, the solid-state proton conductive network has a proton conductivity at above 100° C. that is at least three orders of magnitude higher than proton conductivity of a fuel cell that is based on water for proton conductivity at above 100° C.

In accordance with aspects of the present disclosure, a method of fabricating a polymer electrolyte membrane of a fuel cell includes: setting a radiation dose and dose rate, irradiating a fluorocarbon polymer substrate based on the dose and dose rate to produce free radical sites, introducing an ionic liquid to the fluorocarbon polymer substrate with the ionic liquid grafting to the fluorocarbon polymer substrate at the free radical sites to form a membrane, and heat-treating the membrane at a temperature and for a duration, wherein the radiation dose and dose rate and the heat-treating temperature and duration are configured to achieve grafting of the ionic liquid to the fluorocarbon polymer substrate through a depth of the fluorocarbon polymer substrate.

In various embodiments of the fabricating method, the ionic liquid is a heterocyclic protic ionic liquid that includes chemical structure having at least one vinyl group.

In various embodiments of the fabricating method, the ionic liquid includes at least one of: 4-vinylpyridine, 5-vinylpyrimidine, 5-vinylbenzoimidazole, 2-vinylimidazole, 4-vinylimidazol, 5-vinyl(1,2,3 triazine), 2-vinyl(1,2,5 triazine), 4-vinylbenzene (1 boronic acid), 5-vinylbenzene (1,3 diboronic acid), 2-vinylbenzene (1,3,5 triboronic acid), 4-vinylbenzoic acid, 5-vinylbenzene (1,3 dicarboxylic acid), 2-vinylbenzene (1,3,5 tricarboxylic acid), 4-vinylbenzene (1 sulfonic acid), 5-vinylbenzene (1,3 disulfonic acid), 2-vinylbenzene (1,3,5 trisulfonic acid), 4-vinylbenzene (1 sulfuric acid), 5-vinylbenzene (1,3 disulfuric acid), 2-vinylbenzene (1,3,5 trisulfuric acid), 4-vinylbenzene (1 phosphonic acid), 5-vinylbenzene (1,3 diphosphonic acid), 2-vinylbenzene (1,3,5 triphosphonic acid), 4-vinylbenzene (1 phosphoric acid), 5-vinylbenzene (1,3 diphosphoric acid), 2-vinylbenzene (1,3,5 triphosphoric acid), allyl counterparts of the foregoing vinyl monomers, or butylene counterparts of the foregoing vinyl monomers.

In various embodiments of the fabricating method, the fluorocarbon polymer substrate includes at least one of: fluorinated ethylene propylene (FEP), polychlorotrifluoroethylene (PCTFE), or polyvinylfluoride (PVF).

In various embodiments of the fabricating method, the depth in an entire depth of the fluorocarbon polymer substrate, and the ionic liquid is uniformly diffused through the entire depth of the fluorocarbon polymer substrate.

In various embodiments of the fabricating method, the ionic liquid is grafted to the fluorocarbon polymer substrate with gradually changing density.

In accordance with aspects of the present disclosure, a method of operating a fuel cell having an ionic liquid grafted fluorocarbon polymer membrane is disclosed and includes: operating the fuel cell at a temperature above 100° C., and providing proton conductivity through the ionic liquid grafted fluorocarbon polymer membrane at greater than 0.001 Siemens per centimeter.

In various embodiments of the operating method, providing the proton conductivity includes providing the proton conductivity through the ionic liquid grafted fluorocarbon polymer membrane at greater than 0.01 Siemens per centimeter.

In various embodiments of the operating method, the ionic liquid grafted fluorocarbon polymer membrane includes 5-vinylpyrimidine grafted on polyvinyl fluoride (PVF).

Further details and aspects of exemplary embodiments of the present disclosure are described in more detail below with reference to the appended figures.

### BRIEF DESCRIPTION OF THE DRAWINGS

The above and other aspects and features of the present disclosure will become more apparent in view of the following detailed description when taken in conjunction with the accompanying drawings wherein like reference numerals identify similar or identical elements and:

FIG. 1 is a diagram of an exemplary polymer electrolyte membrane fuel cell, in accordance with aspects of the present disclosure;

FIG. 2 is a diagram of an exemplary fluorocarbon polymers, in accordance with aspects of the present disclosure;

FIG. 3 is a diagram of chemical structures of exemplary ionic liquids, in accordance with aspects of the present disclosure;

FIG. 4 is a diagram of exemplary proton hopping, in accordance with aspects of the present disclosure;

FIG. 5 is a diagram of an exemplary grafting front model operation for radiation grafting ionic liquids onto fluorocarbon polymer substrates, in accordance with aspects of the present disclosure;

FIG. 6 is a diagram of an exemplary indirect radiation grafting operation, in accordance with aspects of the present disclosure;

FIG. 7 is a diagram of an exemplary direct radiation grafting operation, in accordance with aspects of the present disclosure;

FIG. 8 is a diagram of an exemplary radiation grafting operation in which grafting sites remain active, in accordance with aspects of the present disclosure;

FIG. 9 is a diagram of exemplary radiation grafting techniques for mitigating radiation grafting complications, in accordance with aspects of the present disclosure; and

FIG. 10 is a diagram of exemplary proton conductivity measures for various ionic liquid grafted polymer electrolyte membranes, in accordance with aspects of the present disclosure.

### DETAILED DESCRIPTION

The present disclosure relates to ionic liquid grafted conductive membranes for fuel cells and methods for fabricating such membranes. As will be explained below and in connection with the figures, the present disclosure provides anhydrous proton conductive membranes usable for fuel cell applications operating at high temperatures greater than 100° C. In various embodiments, such conductive membranes can be synthesized from radiation grafting of ionic liquids onto fluorocarbon polymer substrates. As used herein, the terms “proton conductive membrane” and “polymer electrolyte membrane” may be used interchangeably.

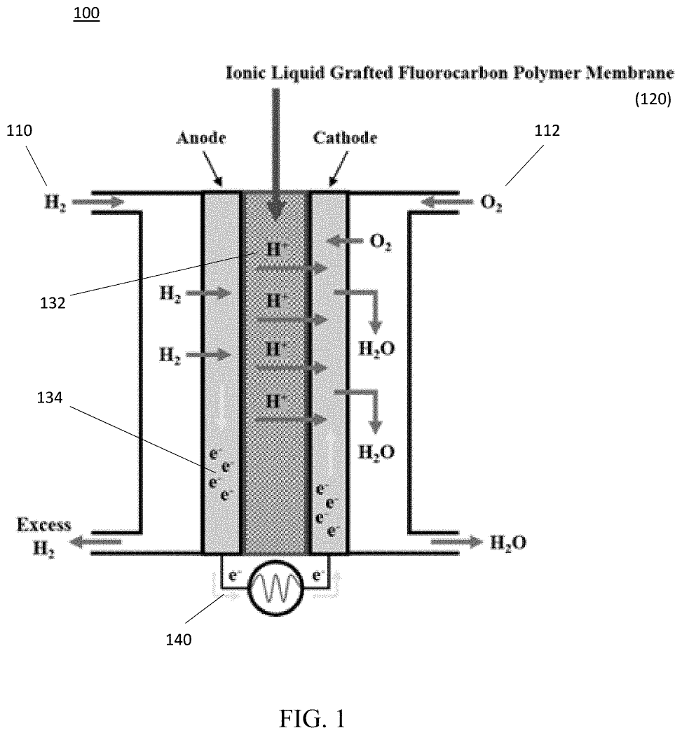

Referring now to FIG. 1, there is shown an exemplary polymer electrolyte membrane (PEM) fuel cell system 100. The PEM fuel cell 100 transforms chemical energy produced from electrochemical reaction of hydrogen and oxygen into electrical energy. A supply of hydrogen 110 is delivered to the anode side of the membrane 120, and at the anode side the hydrogen is catalytically split into protons 132 (i.e., hydrogen ions) and electrons 134. The protons 132 permeate through the polymer electrolyte membrane 120 to the cathode side, while the electrons 134 travel along a circuit 140 to the cathode side of the membrane 120, thereby creating the current output of the fuel cell. At the same time, a supply of oxygen 112 is delivered to the cathode side of the membrane 120, and at the cathode side, the oxygen molecules react with the protons 132 permeating through the membrane 120 and with the electrons 134 arriving through the circuit 140, to form water molecules. The membrane operates to conduct protons 132 (hydrogen ions) but not electrons 134 to avoid short-circuiting the fuel cell. The membrane 120 also operates to halt gas from passing through the membrane to the other side of the fuel cell.

In accordance with aspects of the present disclosure, the membranes of the present disclosure have the following properties: high proton conductivity, low electrical conductivity, high mechanical properties, high chemical resistance, high temperature stability, and humidity independence. The substrate material of the membrane 120 serves as the foundation of the PEM. As mentioned above, higher temperatures enable the fuel cell 100 to operate more efficiently. In accordance with aspects of the present disclosure, the substrate material of the membrane 120 can include fluorocarbon polymers that have properties to withstand the environment of high temperature fuel cell operation. In various embodiments, the substrate material can include fluorocarbon polymers such as polytetrafluoroethylene (PTFE), fluorinated ethylene-co-propylene (FEP), polyvinyl fluoride (PVF), polyvinyl difluoride (PVDF), polyfluoroacrylate (PFA), and polychlorotrifluoroethylene (PCTFE), which are chemically resistant polymers with high melting points, high glass transition temperatures, and low electrical conductivity. These polymers are exemplary, and other polymers having the disclosed properties are contemplated to be within the scope of the present disclosure.

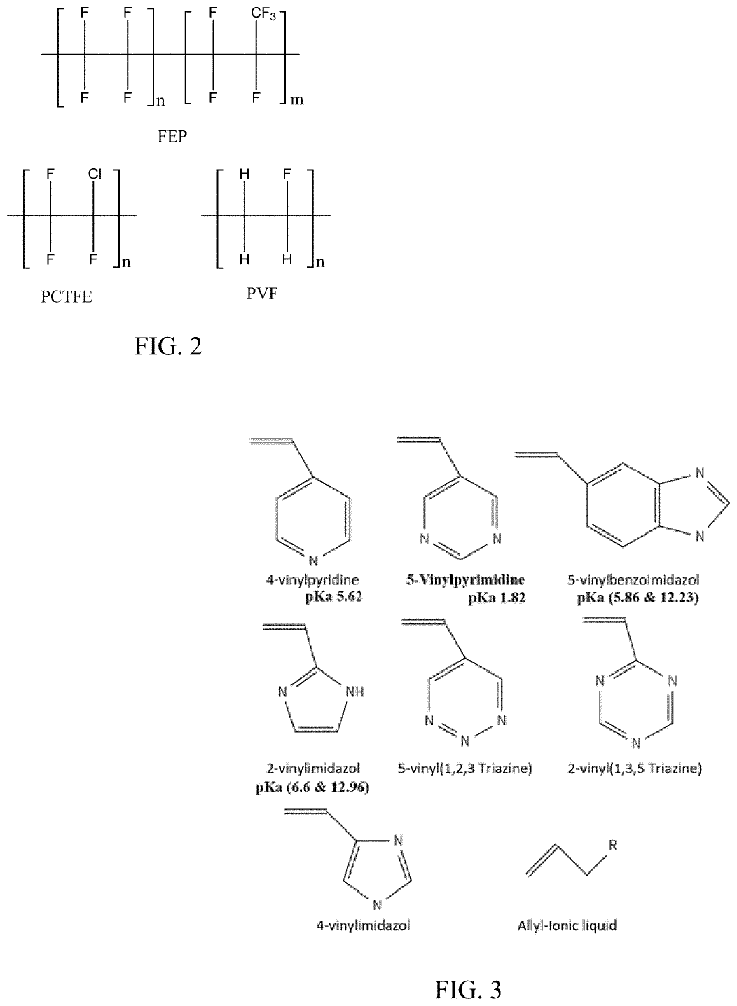

In accordance with aspects of the present disclosure, substrate polymers which exhibit radiation resistance are beneficial. Radiation grafting will be described in more detail in connection with FIGS. 5-7. For now, it is sufficient to note that among the fluorocarbon polymers mentioned above, FEP, PCTFE, and PVF have functional groups which provide a higher degree of radiation resistance. The chemical structures of these fluorocarbon polymers are shown below in FIG. 2. When these polymers are exposed to radiation, their functional groups offer protection to the polymer backbone by mitigating or preventing radiation degradation. If back bone scissions occur, the average molecular weight of the polymer decreases, thereby reducing the mechanical properties of the membrane. Accordingly, polymers having functional groups which offer protection to the polymer backbone are beneficial.

Referring again to FIG. 1, when operating the fuel cell 100 at high temperatures above 100° C., water is not suitable for proton transport because evaporation of the water in the membrane 120 decreases conductivity. In order for the membrane 120 to have high proton conductivity at high temperatures, another substance capable of conducting protons at such temperatures is used.

In accordance with aspects of the present disclosure, ionic liquids having high ionic, electron, and proton conductivity, low vapor pressure, high electrochemical stability, and high thermal stability and decomposition temperatures, are used in the fuel cell membrane 120. Generally, ionic liquids include aprotic, protic, and zwitterionic liquids. In various embodiments, protic ionic liquids are suitable for solid state proton conductivity.

Protic ionic liquids have functional groups that can accept and release protons and therefore can be used for proton transport. In various embodiments, the protic ionic liquids can be heterocyclic amine protic ionic liquids, such as imidazole, pyrazole, triazole, and/or benzimidazole, which are suitable proton solvents to replace water in the PEM fuel cell 100. The proton conductivity of protic ionic liquids is reflected in the dissociation constants (pKa) between the proton donor and acceptor within the system. The energy to oscillate between these two energy states can be provided by a higher operating temperature of the membrane 120. In various embodiments, ionic liquids include 4-vinylpyridine, 5-vinylpyrimidine, 5-vinylbenzoimidazole, and/or 2-vinylimidazole, whose chemical structures and pKa are shown in FIG. 3. Other ionic liquids in accordance with the present disclosure are also shown in FIG. 3. Such protic ionic liquids are suitable for radiation grafting to the fluorocarbon polymer substrate to create the disclosed membrane, which will be described in more detail later herein.

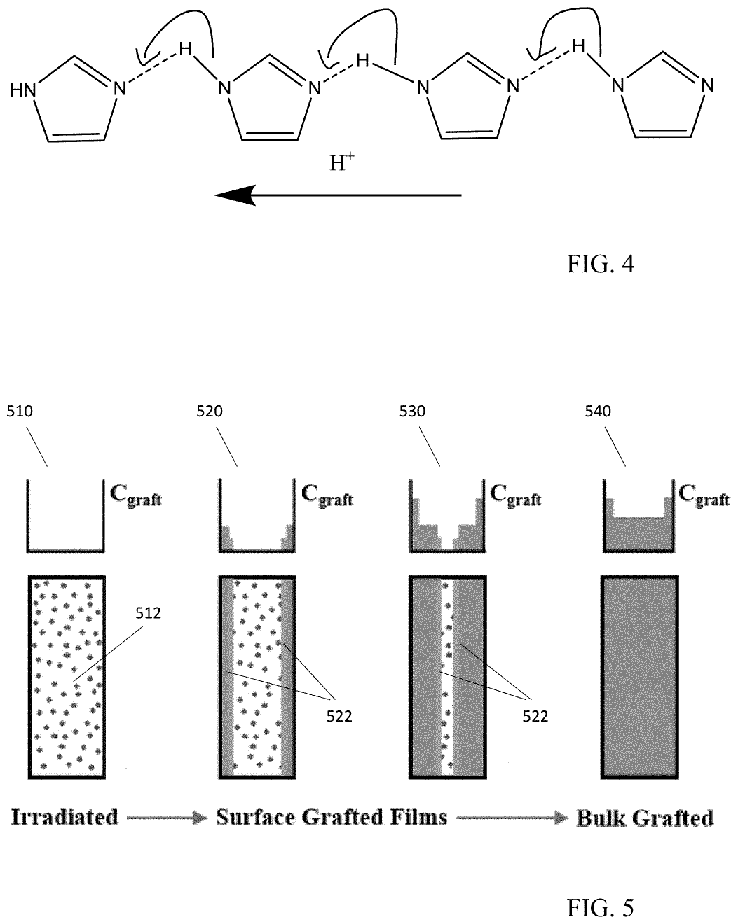

Monomer symmetry beneficially decreases the activation energy for proton conductivity between grafted ionic liquid groups. FIG. 4 shows an example of imidazole proton conductivity. In the example of FIG. 4, imidazole proton conductivity can occur by H+ exchange of near neighbors, which act as both proton donors and acceptors. In this manner, a protic ionic liquid is similar to water by the ability to exchange hydrogen with neighboring cyclic amines.

The ionic liquids described above are exemplary and do not limit the scope of the present disclosure. Generally, proton conductive ionic liquids, that can be radiation grafted to a substrate material to support proton conductivity, are contemplated to be within the scope of the present disclosure. In various embodiments, ionic liquids including nitrogen-based and/or phosphorus-based cations may be used. In various embodiments, ionic liquids containing one or more of the following can be used: 4-vinylimidazol, 5-vinyl(1,2,3 triazine), 2-vinyl(1,2,5 triazine), 4-vinylbenzene (1 boronic acid), 5-vinylbenzene (1,3 diboronic acid), 2-vinylbenzene (1,3,5 triboronic acid), 4-vinylbenzoic acid, 5-vinylbenzene (1,3 dicarboxylic acid), 2-vinylbenzene (1,3,5 tricarboxylic acid), 4-vinylbenzene (1 sulfonic acid), 5-vinylbenzene (1,3 disulfonic acid), 2-vinylbenzene (1,3,5 trisulfonic acid), 4-vinylbenzene (1 sulfuric acid), 5-vinylbenzene (1,3 disulfuric acid), 2-vinylbenzene (1,3,5 trisulfuric acid), 4-vinylbenzene (1 phosphonic acid), 5-vinylbenzene (1,3 diphosphonic acid), 2-vinylbenzene (1,3,5 triphosphonic acid), 4-vinylbenzene (1 phosphoric acid), 5-vinylbenzene (1,3 diphosphoric acid), 2-vinylbenzene (1,3,5 triphosphoric acid), allyl counterparts of the foregoing vinyl monomers, or butylene counterparts of the foregoing vinyl monomers. In various embodiments, the ionic liquid monomers may or may not be laced with double bonds vinyl groups.

The description above described substrate materials and ionic liquids for a conductive membrane of a PEM fuel cell. The description below will describe operations for fabricating the disclosed membrane. For ease of explanation, the description below may use the example of radiation grafting a protic ionic liquid to a fluorocarbon polymer substrate. However, it is contemplated that the operations described below apply to radiation grafting of other ionic liquids to other polymer substrates as well.

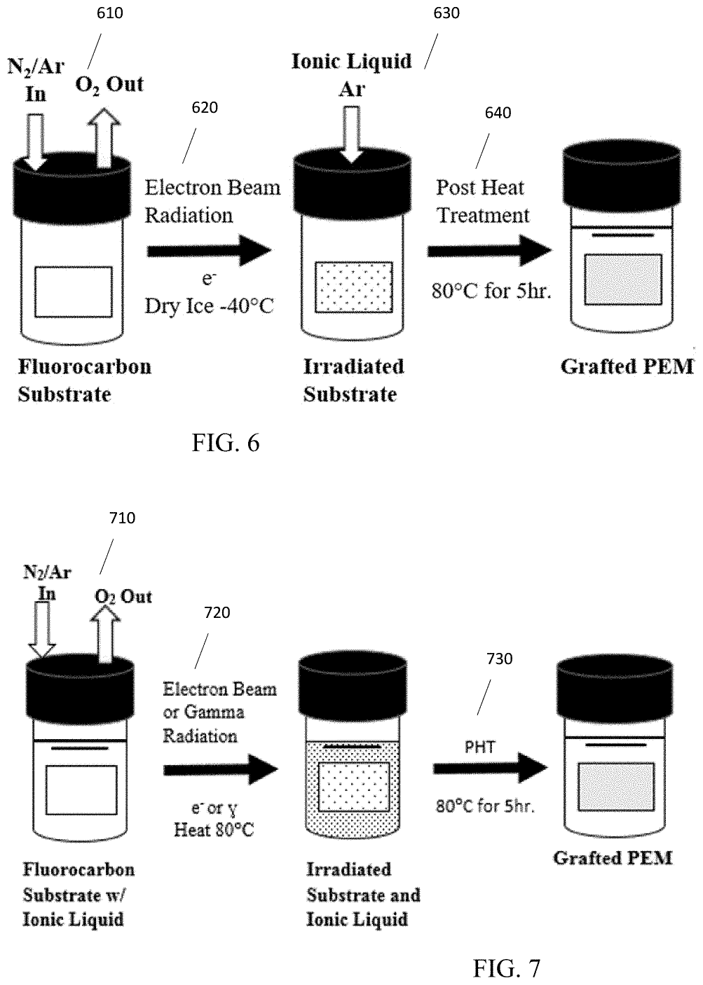

In accordance with aspects of the present disclosure, radiation grafting of protic ionic liquids creates a solid-state proton conductive network within a PEM. Persons skilled in the art will understand radiation grafting techniques. By incorporating protic ionic liquids into fluorocarbon polymer substrates via radiation grafting techniques, a new proton conductive mechanism is provided by the present disclosure. Radiation grafting can be either indirect radiation grafting or direct radiation granting. Indirect radiation grafting is described in connection with FIG. 6, and direct radiation grafting is described in connection with FIG. 7. An electron beam can be used for both radiation-induced indirect grafting and direct grafting. In various embodiments, irradiations are carried out under anaerobic conditions to prevent or mitigate the radiolytically produced radicals from reacting with ambient molecular oxygen.

Referring now to FIG. 5, there is shown a diagram illustrating synthesis of an ionic liquid polymer electrolyte membrane. The operation of FIG. 5 may be referred to herein as “grafting front model.” The illustrated flow applies to either indirect radiation or direct radiation grafting. In general, the operation of FIG. 5 attaches monomers onto fluorocarbon thin films by radiation grafting. As mentioned above, the fluorocarbon films can include fluorocarbon polymers having functional groups which offer protection to the polymer backbone, such as fluorinated ethylene propylene (FEP), polychlorotrifluoroethylene (PCTFE), and/or polyvinylfluoride (PVF).

At step 510, radiation generates free radicals in fluorocarbon polymer substrates and/or unsaturated carbon groups (such as vinyl and allyl groups) in the ionic liquids. The free radicals are depicted as dots and are active sites 512 for grafting. With direct radiation graft polymerization, the fluorocarbon polymer substrate and the ionic liquid monomer are simultaneously irradiated. In contrast, with indirect grafting polymerization, the fluorocarbon polymer substrate is first irradiated followed by the introduction of the monomer to the system. Step 510 is intended to illustrate cover direct radiation grafting and indirect radiation grafting. At step 520, grafting initially occurs at the surface by polymerization of monomers in solution, which produces a grafting front 522. The grafting is facilitated between the radiation induced free radicals 512. At step 530, the active sites 512 within the irradiated film are further grafted by diffusion of monomers through the already grafted swollen polymer zone. Over time, the grafting front 522 shifts from the surfaces to the interior. At step 540, further grafting increases the concentration of monomer in the membrane, and grafting for a sufficient time duration yields homogeneous grafted films with the same concentration or approximately the same concentration grafted over the entire film thickness. The length of time duration sufficient to achieve a homogeneous grafted film can vary, and all such time durations are contemplated to be within the scope of the present disclosure.

With continuing reference to FIG. 5, and in various embodiments, the radiation of step 510 can be electron beam radiation. Grafting with electron beam radiation requires no catalyst and can be performed at a wide range of temperatures with little or no solvents or additives. The radiation parameters can be optimized to achieve bulk radiation grafting and create a uniform structure throughout the depth of the PEM, as shown in step 540. The degree of grafting can be controlled by the radiation dose, dose rate, and temperature. Persons skilled in the art will recognize how to adjust radiation and temperature parameters to achieve a desired grafting result. Because ionizing radiation penetrates the entire depth of the substrate material, fuel cell membranes fabricated in the manner of FIG. 5 can provide ion-conducting monomers that are deeply and evenly embedded within the substrate polymer. Membranes synthesized in such manner provide high proton conductivity, thermal stability, and good mechanical properties at high temperatures above 100° C. Additionally, the conductivity of such membranes is humidity independent, which allows for more reliable performance and higher power density fuel cells.

The embodiment of FIG. 5 is exemplary, and variations are contemplated to be within the scope of the present disclosure. For example, in various embodiments, the grafting front model can be used to generate asymmetrically grafted membranes (not shown). As an example, a thin hydrophobic barrier can be grated onto one side of the membrane while a proton conductor can be grafted through the membrane's thickness in the manner described above. Such an embodiment allows membranes to be fabricated with either gradually (e.g., smoothly) changing dopant density or abrupt composition changes, which allow for directional transport of ionic (i.e., protons) through the membrane. Other variations are contemplated to be within the scope of the present disclosure.

FIG. 6 shows an example of an indirect radiation grafting operation for synthesizing a proton conductive membrane. As mentioned above, an indirect radiation grafting technique operates to irradiate a fluorocarbon polymer substrate prior to monomer addition. This order of treatment mitigates or prevents free radical polymerization of the ionic liquid monomer and allows diffusion and bulk grafting. The parameters of radiation dose, dose rate, and temperature can be adjusted to improve the uniformity of the ionic liquid PEM. In various embodiments, the fluorocarbon polymer substrate can be irradiated using an 10 MeV electron beam.

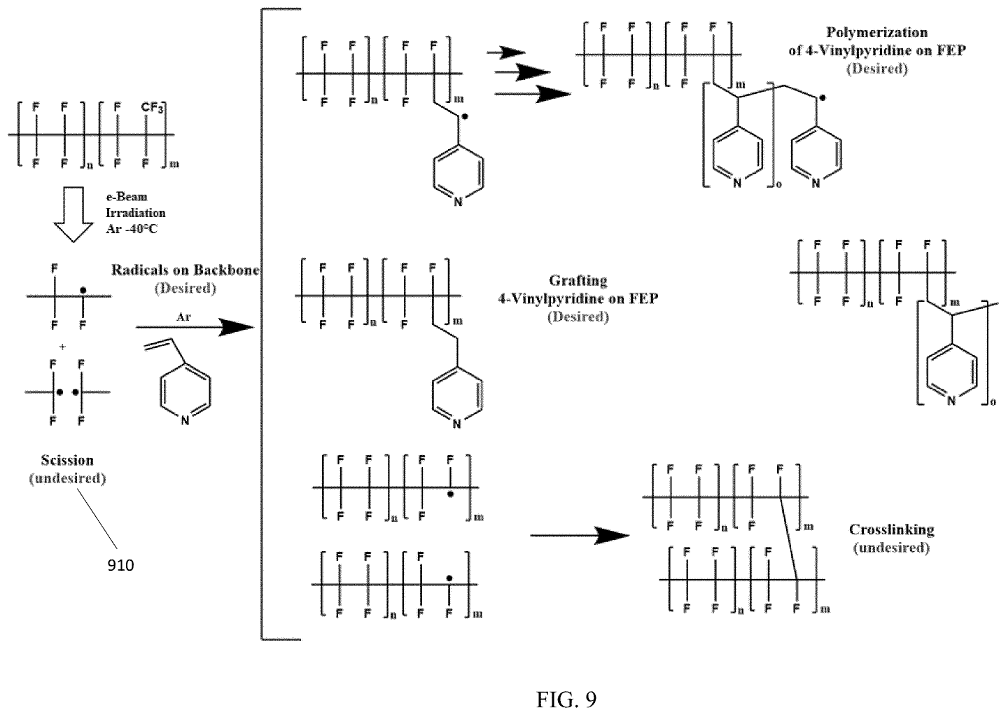

Initially, at step 610, inert gas is used to purge the substrate of oxygen to mitigate or prevent oxygen from reacting with free radicals to be generated in the fluorocarbon polymer substrate. At step 620, the fluorocarbon polymer substrate is irradiated to generate the free radicals and is cooled. At step 630, after the substrate is irradiated and cooled, the indirect grafting operation involves bubbling the substrates with argon under an inert atmosphere and using chambers or glove bags for the protic ionic liquid addition. At step 640, a post heat treatment is performed at a temperature above the glass transition temperature of the grafted polymers for a sufficient time duration to allow uniform diffusion and grafting. In various embodiments, a higher temperature corresponds to greater radical mobility and probability of undesired crosslinking. Persons skilled in the art will understand how to ascertain an appropriate temperature and time duration to allow uniform or substantially uniform diffusion and grafting. Additionally, techniques for addressing undesired crosslinking are addressed below in connection with FIG. 9.

FIG. 7 shows an example of a direct radiation grafting operation for synthesizing a proton conductive membrane. As mentioned above, a direct radiation graft operates to simultaneously irradiate the fluorocarbon polymer substrate and the ionic liquid monomer. Initially, at step 710, inert gas is used to purge the substrate and ionic liquid of oxygen to mitigate or prevent oxygen from reacting with free radicals to be generated in the fluorocarbon polymer substrate and the ionic liquid. At step 720, the fluorocarbon polymer substrate and the ionic liquid are irradiated to generate the free radicals. At step 730, after the substrate and ionic liquid are irradiated, a post heat treatment is performed at a temperature above the glass transition temperature of the grafted polymers for a sufficient time duration to allow diffusion and grafting.

Direct radiation grafting as shown in FIG. 7 may be used where uniform bulk grafted ionic liquid membranes are not required. High concentration of monomer is needed to drive the diffusion of the monomer into the substrate. When the monomers are irradiated with direct radiation grafting, the monomers polymerize in solution, which sterically hinders their diffusion into the membrane. The resulting membrane, therefore, has lower degrees of grafting and non-uniform grafting and may have ionic liquids grafted only on the surface of the substrate.

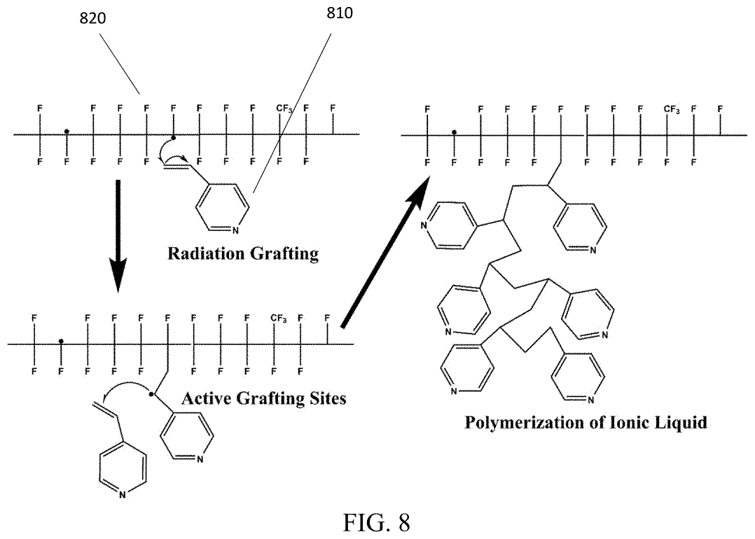

Referring now to FIG. 8, there is shown an example of grafting a monomer 810 to a fluorocarbon polymer substrate 820. The illustration shows how a double bond present in the monomer 810 (4-vinylpyridine) is used in the radiation grafting synthesis to allow a grafting site to remain active and permit branch polymerization of the ionic liquid in the fluorocarbon polymer substrate 820. Allowing a grafting site to remain active promotes the development of ionomer nanochannels in the amorphous regions of the fluorocarbon polymer substrate where grafting is more prevalent. N—H bonds of heterocyclic amine ionic liquids (4-vinylpyridine and 5-vinylpyrimidie) are used to create hydrogen bond networks in the nanochannels, which promotes the mechanism of proton hoping. The ionic liquid monomers 810 are physically covalently bonded to the substrate 820, thereby mitigating or preventing the possibility of electrochemical breakdown or phase separation.

As described above, high energy ionizing radiation sources are utilized to treat fluorocarbon polymer substrates to ionize electrons to generate free radicals, and the radiation induced free radicals react with the double bond of the protic ionic liquids to graft directly onto the fluorocarbon polymer substrate. Additional undesired reactions including backbone chain scissions and crosslinking between polymer chains may also occur.

FIG. 9 shows examples of desired and undesired reactions of indirect radiation grafting synthesis of protic heterocyclic ionic liquid fluorocarbon polymer membranes. In the example, optimization of irradiation parameters can promote radiation induced grafting reactions over the undesired reactions. Following irradiation, radicals are formed along the backbone of the polymer through either defluorination or backbone chain scissions 910. Carbon centered free radicals in fluorocarbon polymers have higher stability than in hydrocarbon polymers due to their lower mobility along the chains which is reflected by longer half-lives. This longer half-life is due to the greater steric hindrance of fluorine versus hydrogen in the backbone. During radiation treatment, dry ice can be used to cool substrates below −40° C., as shown in FIG. 6, to preserve the generated radicals by reducing their mobility. In accordance with aspects of the present disclosure, it has been determined that low dose rates mitigate crosslinking and produce higher and more uniform grafted PEMs. The dose levels for each specific protic ionic liquid may need to be individually optimized.

Table I below provides exemplary parameters for indirect radiation grafting, including three parameters that should be optimize for the grafting process: dose, dose rate, and post heat treatment (PHT) temperature/duration. Table I reflects an indirect grafting procedure for grafting 4-vinylpyridine or 5-vinylpyrimidine to a fluorocarbon polymer substrate of FEP, PCTFE, or PVF, without lacing the ionic liquid monomers with double bonds vinyl groups.

TABLE I

| Sample # | | Dose | | Dose Rate | Irradiation | | % | | |
|---|---|---|---|---|---|---|---|---|---|
| 3222017 | Monomer | (kGy) | | (1000 kGy/hr) | Temperature | PHT | Grafting | Std | Repetitions |
| FEP-1 (a-e) | 5-vinylpyrimidine | 25 | kGy | 1000 kGy/hr | −45 °C. | 80 °C. 5 hr. | 19.62 | 3.18 | 5 |
| PCTFE-3 (a-e) | 5-vinylpyrimidine | 100 | kGy | 1000 kGy/hr | −45 °C. | 80 °C. 5 hr. | 11.82 | 2.77 | 5 |
| PVF-1(a-e) | 5-vinylpyrimidine | 25 | kGy | 1000 kGy/hr | −45 °C. | 80 °C. 5 hr. | 44.63 | 4.95 | 5 |
| PVF-3(a-e) | 5-vinylpyrimidine | 100 | kGy | 1000 kGy/hr | −45 °C. | 80 °C. 5 hr. | 29.45 | 3.49 | 5 |
| PCTFE-2 (a-e) | 4-vinylpyridine | 50 | kGy | 1000 kGy/hr | −45 °C. | 80 °C. 5 hr. | 7.70 | 4.95 | 5 |
| PCTFE-1 (a-e) | 4-vinylpyridine | 100 | kGy | 1000 kGy/hr | −45 °C. | 80 °C. 5 hr. | 20.23 | 5.64 | 5 |
| FEP-3 (a-e) | 4-vinylpyridine | 50 | kGy | 1000 kGy/hr | −45 °C. | 80 °C. 5 hr. | 18.57 | 4.57 | 5 |

It has been determined that a dose rate of 1000 kGy/hour achieved an acceptable level of grafting in the grafting procedure.

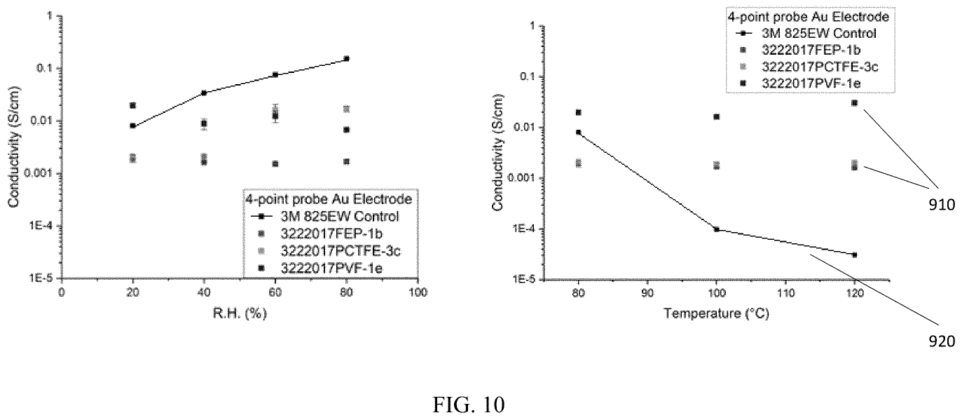

Referring to FIG. 10, charts are provided to illustrate proton conductivity of PEMs synthesized via indirect radiation grafting of 5-vinylpyrimidine on FEP, PCTFE, and PVF, at various humidity and temperatures. The control measurement is a measure of conductivity for a traditional 3M™ 825 EW PEM. The illustrated conductivity measurements were taken by electrochemical impedance spectroscopy (EIS) measurements. For the measurements, the membranes were treated with 5% HNO₃. The charts show that, at high temperatures above 100° C. where water evaporates, proton conductivity in the disclosed membranes 1010 is facilitated by the grafted ionic liquids and not by water.

FIG. 10 shows the contrast in proton conductivity at high temperatures between a traditional PEM (e.g., 3M™ 825 EW) and a radiation grafted ionic liquid PEM 910 of the present disclosure. The proton conductivity of ionic liquid PEMs 910 increases at higher temperatures, whereas traditional PEMs that rely on hydronium ions and water channels for proton transport dehydrate when approaching 100° C., causing a dramatic decrease in proton conductivity 920. The proton conductivity of the ionic liquid PEMs 910 is tied to the density of the grafted ionic liquid branches and electrochemical properties of the ionic liquid monomer. Use of heterocyclic protic ionic liquids that have vinyl groups suitable for radiation grafting, is beneficial. The non-polar chemical structure of the heterocyclic amines ionic liquid allows for high diffusivity into the fluorocarbon polymer substrates. The monomer symmetry decreases the activation energy for proton transfer between grafted ionic liquid groups, allowing for Grotthuss proton hopping. The vinyl group allows radiation grafting sites in the membrane to remain active and the polymerization of the ionic liquid in the amorphous regions of the fluorocarbon polymer substrate.

Accordingly, by synthesizing PEMs that incorporate protic ionic liquids, proton transport can be supported for high temperature and anhydrous PEM fuel cell applications. The ionic liquid fuel cell membranes prepared as shown in FIG. 6 with PVF and 5-vinylpyrimidine are able to operate at temperatures above 100° C. with three orders of magnitude higher proton conductivity than traditional PEMs. As shown in FIG. 10, a traditional PEM provides less than 10′ Siemens/cm above 100° C. In contrast, 5-vinylpyrimidine grafted on FEP or PCTFE provides more than 0.001 Siemens/cm above 100° C., and 5-vinylpyrimidine grafted on PVF provides more than 0.01 Siemens/cm above 100° C. Operating at this higher temperature region improves performance and reliability of fuel cells, including increasing proton mobility, enhancing reaction kinetics, increasing catalysis activity, and reducing carbon monoxide poisoning. Traditional PEM fuel cells such as DuPont's Nafion™ and 3M's 825EW do not operate efficiently approaching temperatures above 100° C. because water is used as a proton conductive medium. By substituting water with protic ionic liquids that are grafted onto fluorocarbon films, a new proton conductive network solid state PEM is developed by the present disclosure. The disclosed membranes can perform at a higher temperature range above 100° C.

Anhydrous fuel cell membranes of the present disclosure allow higher temperature operation and removal of redundant water management systems required to regulate fuel cell power output. The protic ionic liquid membranes disclosed herein are compatible with existing fuel cell systems, including fuel cells for automobile industry power density and scalability, among other industries and applications.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. The embodiments described and illustrated herein are exemplary, and variations are contemplated to be within the scope of the present disclosure. Various embodiments disclosed herein can be combined in ways not expressly described herein, and such combinations are contemplated to be within the scope of the present disclosure. Other elements, steps, methods, and techniques that are insubstantially different from those described above and/or in the appended claims are also intended to be within the scope of the disclosure.

What is claimed is:

1. A fuel cell comprising:
a membrane including:
ionic liquid monomers physically covalently bonded to a fluorocarbon polymer substrate, and
a solid-state proton conductive network configured to conduct protons above 100° C.

2. The fuel cell according to claim 1, wherein the ionic liquid monomers are heterocyclic protic.

3. The fuel cell according to claim 2, wherein the ionic liquid monomers include at least one vinyl group.

4. The fuel cell according to claim 3, wherein the membrane further includes ionomer nanochannels, wherein the ionomer nanochannels include hydrogen bond networks.

5. The fuel cell according to claim 1, wherein the fluorocarbon polymer substrate includes a fluoropolymer having a functional group which provides protection to a polymer backbone.

6. The fuel cell according to claim 5, wherein the fluorocarbon polymer substrate includes at least one of: fluorinated ethylene propylene (FEP), polychlorotrifluoroethylene (PCTFE), or polyvinylfluoride (PVF).

7. The fuel cell according to claim 1, wherein the ionic liquid includes at least one of: 4-vinylpyridine, 5-vinylpyrimidine, 5-vinylbenzoimidazole, or 2-vinylimidazole, 4-vinylimidazol, 5-vinyl(1,2,3 triazine), 2-vinyl(1,2,5 triazine), 4-vinylbenzene (1 boronic acid), 5-vinylbenzene (1,3 diboronic acid), 2-vinylbenzene (1,3,5 triboronic acid), 4-vinylbenzoic acid, 5-vinylbenzene (1,3 dicarboxylic acid), 2-vinylbenzene (1,3,5 tricarboxylic acid), 4-vinylbenzene (1 sulfonic acid), 5-vinylbenzene (1,3 disulfonic acid), 2-vinylbenzene (1,3,5 trisulfonic acid), 4-vinylbenzene (1 sulfuric acid), 5-vinylbenzene (1,3 disulfuric acid), 2-vinylbenzene (1,3,5 trisulfuric acid), 4-vinylbenzene (1 phosphonic acid), 5-vinylbenzene (1,3 diphosphonic acid), 2-vinylbenzene (1,3,5 triphosphonic acid), 4-vinylbenzene (1 phosphoric acid), 5-vinylbenzene (1,3 diphosphoric acid), 2-vinylbenzene (1,3,5 triphosphoric acid), allyl counterparts of the foregoing vinyl monomers, or butylene counterparts of the foregoing vinyl monomers.

8. The fuel cell according to claim 1, wherein the ionic liquid monomers are diffused through a depth of the fluorocarbon polymer substrate.

9. The fuel cell according to claim 8, wherein the depth is an entire depth of the fluorocarbon polymer substrate, wherein the ionic liquid monomers are uniformly diffused through the entire depth of the fluorocarbon polymer substrate.

10. The fuel cell according to claim 1, wherein the membrane conducts protons independent of humidity.

11. The fuel cell according to claim 1, wherein the solid-state proton conductive network has a proton conductivity at above 100° C. that is at least three orders of magnitude higher than proton conductivity of a fuel cell that is based on water for proton conductivity at above 100° C.

12. A method of fabricating a polymer electrolyte membrane of a fuel cell, comprising:
setting a radiation dose and dose rate;
irradiating a fluorocarbon polymer substrate based on the dose and dose rate to produce free radical sites;
introducing an ionic liquid to the fluorocarbon polymer substrate, the ionic liquid grafting to the fluorocarbon polymer substrate at the free radical sites to form a membrane; and
heat-treating the membrane at a temperature and for a duration,
wherein the radiation dose and dose rate and the heat-treating temperature and duration are configured to achieve grafting of the ionic liquid to the fluorocarbon polymer substrate through a depth of the fluorocarbon polymer substrate.

13. The method of claim 12, wherein the ionic liquid is a heterocyclic protic ionic liquid that includes chemical structure having at least one vinyl group.

14. The method of claim 13, wherein the ionic liquid includes at least one of: 4-vinylpyridine, 5-vinylpyrimidine, 5-vinylbenzoimidazole, 2-vinylimidazole, 4-vinylimidazol, 5-vinyl(1,2,3 triazine), 2-vinyl(1,2,5 triazine), 4-vinylbenzene (1 boronic acid), 5-vinylbenzene (1,3 diboronic acid), 2-vinylbenzene (1,3,5 triboronic acid), 4-vinylbenzoic acid, 5-vinylbenzene (1,3 dicarboxylic acid), 2-vinylbenzene (1,3,5 tricarboxylic acid), 4-vinylbenzene (1 sulfonic acid), 5-vinylbenzene (1,3 disulfonic acid), 2-vinylbenzene (1,3,5 trisulfonic acid), 4-vinylbenzene (1 sulfuric acid), 5-vinylbenzene (1,3 disulfuric acid), 2-vinylbenzene (1,3,5 trisulfuric acid), 4-vinylbenzene (1 phosphonic acid), 5-vinylbenzene (1,3 diphosphonic acid), 2-vinylbenzene (1,3,5 triphosphonic acid), 4-vinylbenzene (1 phosphoric acid), 5-vinylbenzene (1,3 diphosphoric acid), 2-vinylbenzene (1,3,5 triphosphoric acid), allyl counterparts of the foregoing vinyl monomers, or butylene counterparts of the foregoing vinyl monomers.

15. The method of claim 14, wherein the fluorocarbon polymer substrate includes at least one of: fluorinated ethylene propylene (FEP), polychlorotrifluoroethylene (PCTFE), or polyvinylfluoride (PVF).

16. The method of claim 12, wherein the depth in an entire depth of the fluorocarbon polymer substrate, wherein the ionic liquid is uniformly diffused through the entire depth of the fluorocarbon polymer substrate.

17. The method of claim 12, wherein the ionic liquid is grafted to the fluorocarbon polymer substrate with gradually changing density.

18. A method of operating a fuel cell having an ionic liquid grafted fluorocarbon polymer membrane, the method comprising:
operating the fuel cell at a temperature above 100° C.; and
providing proton conductivity through the ionic liquid grafted fluorocarbon polymer membrane at greater than 0.001 Siemens per centimeter.

19. The method of claim 18, wherein providing the proton conductivity includes providing the proton conductivity through the ionic liquid grafted fluorocarbon polymer membrane at greater than 0.01 Siemens per centimeter.

20. The method of claim 19, wherein the ionic liquid grafted fluorocarbon polymer membrane includes 5-vinylpyrimidine grafted on polyvinyl fluoride (PVF).
